(19) United States
(12) Patent Application Publication
(10) Pub. No.: US 2017/0052613 A1
(43) Pub. Date: Feb. 23, 2017

(54) Method and Apparatus for In-Purse Detection by an Electronic Device

(71) Applicant: Motorola Mobility LLC, Chicago, IL (US)

(72) Inventors: Rachid M. Alameh, Crystal Lake, IL (US); Sambhavi Jayavelan, Park Ridge, IL (US); Padmaja Putcha, Gurnee, IL (US); Paul Steuer, Hawthorn Woods, IL (US); Ariel P. Sundel, Chicago, IL (US)

(21) Appl. No.: 14/829,107

(22) Filed: Aug. 18, 2015

(51) Int. Cl. G06F 3/044; G06F 3/041; G05B 15/02; G06F 3/16

(52) U.S. Cl. CPC G06F 3/044; G06F 3/165; G06F 3/0412; G05B 15/02

(57) ABSTRACT

A method for controlling an electronic device includes detecting, with one or more sensors, that the electronic device is disposed within a repository container, such as a purse as a function of at least an intensity of received ambient light being below a predefined threshold, an absence of touch sensor actuation along a housing of the electronic device, and an approximately common temperature occurring at both a first location of the electronic device and a second location of the electronic device. When the in-container condition is detected, one or more processors operable with the one or more sensors can perform a control operation.

### BACKGROUND

Technical Field

This disclosure relates generally to electronic devices and corresponding methods, and more particularly to electronic devices with proximity and other sensors.

Background Art

Mobile electronic communication devices, such as mobile telephones, smart phones, gaming devices, and the like, are used by billions of people. These owners use mobile communication devices for many different purposes including, but not limited to, voice communications and data communications for text messaging, Internet browsing, commerce such as banking, and social networking.

As the technology of these devices has advanced, so too has their feature set. For example, not too long ago all electronic devices had physical keypads. Today touch sensitive displays are more frequently seen as user interface devices. Similarly, it used to be that the only way to deliver user input to a device was with touch, either through a keypad or touch sensitive display. Today some devices are equipped with voice recognition that allows a user to speak commands to a device instead of typing them.

These smaller, yet more powerful, devices are being used for many different applications in many different environments. It would be advantageous to be able to detect certain environments and adapt performance of an electronic device to better perform in a given environment.

### BRIEF DESCRIPTION OF THE DRAWINGS

FIG. 1 illustrates a user carrying a prior art purse.

FIG. 2 illustrates explanatory contents and clutter present in a prior art purse.

FIG. 3 illustrates a schematic block diagram of one explanatory electronic device in accordance with one or more embodiments of the disclosure.

FIG. 4 illustrates examples of sensors that can be included in an electronic device configured in accordance with one or more embodiments of the disclosure.

FIG. 5 illustrates explanatory proximity sensor component and proximity detector component configurations in accordance with one or more embodiments of the disclosure.

FIG. 6 illustrates a user placing an electronic device configured in accordance with one or more embodiments of the disclosure into a purse.

FIG. 7 illustrates one or more method steps in accordance with one or more embodiments of the disclosure.

FIG. 8 illustrates one or more method steps in accordance with one or more embodiments of the disclosure.

FIG. 9 illustrates one or more method steps in accordance with one or more embodiments of the disclosure.

FIG. 10 illustrates one or more method steps in accordance with one or more embodiments of the disclosure.

FIG. 11 illustrates one or more method steps in accordance with one or more embodiments of the disclosure.

FIG. 12 illustrates one or more method steps in accordance with one or more embodiments of the disclosure.

FIG. 13 illustrates explanatory control operations suitable for use with methods and electronic devices in accordance with one or more embodiments of the disclosure.

FIG. 14 illustrates one explanatory method for an electronic device in accordance with one or more embodiments of the disclosure.

FIG. 15 illustrates explanatory control operations suitable for use with methods and electronic devices in accordance with one or more embodiments of the disclosure.

FIG. 16 illustrates one or more method steps in accordance with one or more embodiments of the disclosure.

FIG. 17 illustrates one or more method steps in accordance with one or more embodiments of the disclosure.

FIG. 18 illustrates one or more method steps in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting that an electronic device is disposed within a purse. Process descriptions or blocks in a flow chart can be modules, segments, or portions of code that implement specific logical functions of a machine or steps in a process, or alternatively that transition specific hardware components into different states or modes of operation. Alternate implementations are included, and it will be clear that functions may be executed out of order from that shown or discussed, including substantially concurrently or in reverse order, depending on the functionality involved.

It will be appreciated that embodiments of the disclosure described herein may be comprised of one or more conventional processors and unique stored program instructions that control the one or more processors to implement, in conjunction with certain non-processor circuits, some, most, or all of the functions of detecting that an electronic device is disposed within a repository container, such as a purse. The one or more processors can optionally detecting whether the repository container is open, and additionally optionally executing one or more control operations in response to one or more of the in-container condition or the in-open-container condition as described herein. The non-processor circuits may include, but are not limited to, microphones, loudspeakers, acoustic amplifiers, digital to analog converters, signal drivers, clock circuits, sensors, power source circuits, and user input devices. As such, these functions may be interpreted as steps of a method to perform the detection that the device is disposed within a repository container and/or whether the repository container is in an open state or a closed state. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by reducing power consumption, extending run time, and improving the overall user experience to overcome problems specifically arising in the realm of the technology associated with electronic device user interaction.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path. Also, reference designators shown herein in parenthesis indicate components shown in a figure other than the one in discussion. For example, talking about a device (10) while discussing figure A would refer to an element, 10, shown in figure other than figure A.

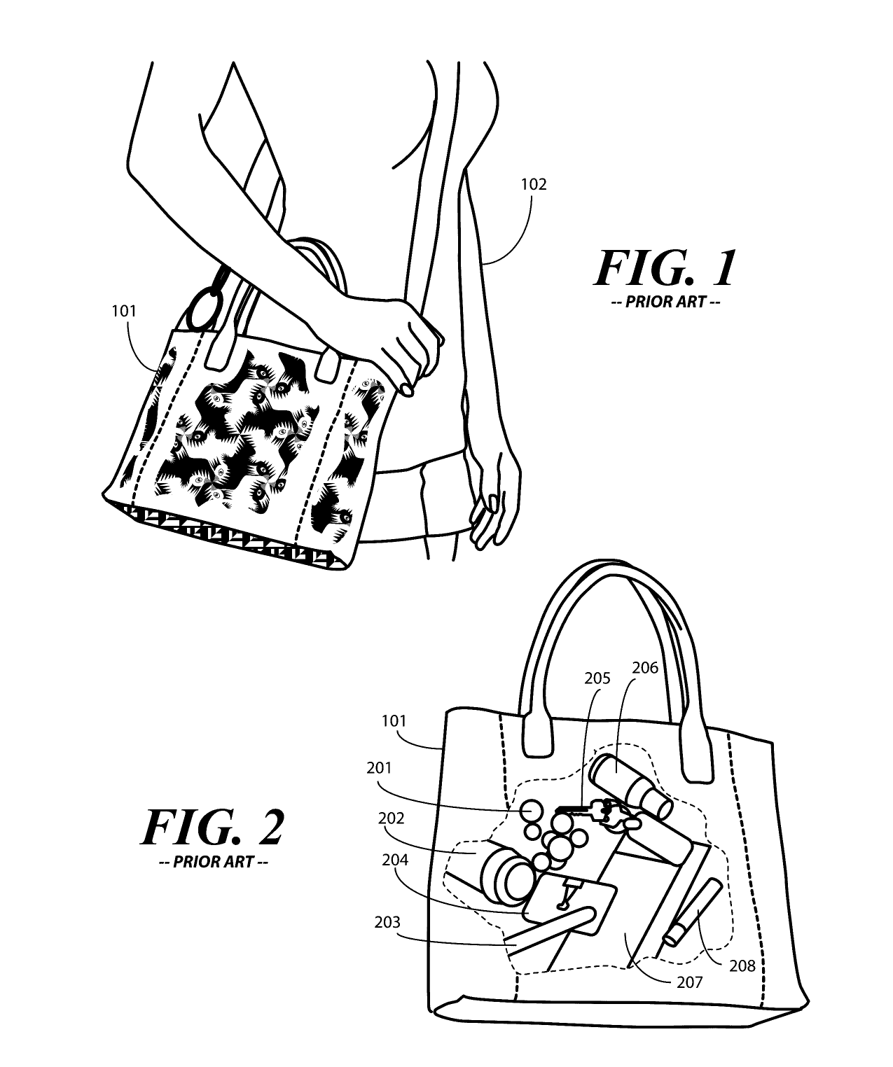

Turning now to FIG. 1, illustrated therein is a person 102 carrying a repository container, which in this case is a purse 101. As used herein, a “repository container” is used to refer to an enclosed or semi-enclosed compartment that is large enough for a portable electronic device, such as a smartphone, to get “lost” therein. Examples of repository containers include the purse 101 of FIG. 1, briefcases, satchels, duffel bags, suitcases, handbags, backpacks, shoulder bags, clutches, computer bags, attaché cases, messenger bags, and so forth. Other examples of repository containers will be obvious to those of ordinary skill in the art having the benefit of this disclosure.

Moreover, a “repository container” as used herein is sufficiently large so that multiple objects or items can be stowed therein so as to make finding a portable electronic device difficult. Illustrating by example, as shown in FIG. 2, in this illustrative embodiment the purse 101 includes numerous items such as coins 201, medications 202, grooming items such as fingernail files 203, notecards 204, keys 205, lotions 206, notepads 207, lip balm 208, and other items. Embodiments of the disclosure contemplate that when a repository container houses several items, it can be difficult to find any one particular item. For instance, while a smartphone is disposed in the purse 101 of FIG. 2, it cannot be seen because it is buried beneath the clutter of other items. Consequently, if the person (102) wants to determine whether the smartphone is buried in the purse 101, this can be a monumental task. The person (102) may need to completely empty the purse 101 to find the smartphone. They then have to put all items back in the purse 101. Not only is this time consuming, they may inadvertently forget an important item, such as their keys 205, when reloading the purse 101.

Embodiments of the present disclosure provide a solution to this dilemma. Specifically, embodiments of the disclosure provide an accurate and repeatable method and apparatus for detecting that an electronic device is disposed within a repository container such as a purse 101, duffle, satchel, briefcase, or other container. Additionally, in one or more embodiments, an electronic device can determine whether the repository container is in an open condition or a closed condition. For example, in one embodiment a method for controlling an electronic device equipped with one or more sensors comprises detecting, with the one or more of the sensors, the electronic device is disposed within the repository container as a function of detecting one or more of an intensity of received ambient light being below a predefined threshold, an absence of touch sensor actuation along a housing of the electronic device, and/or an approximately common temperature occurring at both a first location of the electronic device and a second location of the electronic device. The function can further be of motion of the device, as an electronic device disposed within a repository container will tend to exhibit approximate rotational stability, which is in contrast to situations where it continually changes hands, is in the hand of a user who is walking, or is picked up from a table, where the device would change directions from up to down to angled and so forth.

In one embodiment, when these or other conditions are met, one or more processors operable with the one or more sensors detect that the electronic device is in a repository container rather than another location, such as in their hand, on a table, or disposed within a drawer. In one embodiment, the one or more processors can optionally perform a control operation in response to detecting the electronic device is disposed within the repository container.

Illustrating by example, in one embodiment, when an electronic device is placed within a repository container and the repository container is closed, thermal sensors disposed along surfaces of the electronic device will detect an approximately common temperature occurring at both a first location of the electronic device and a second location of the electronic device. The first location and the second location can be on the same side of the electronic device, or alternatively can be on different sides or ends of the electronic device.

As used herein, the term “approximately” means within a predefined tolerance range, which will usually be a manufacturing tolerance range. For example, if the manufacturing tolerances were plus or minus two degrees Fahrenheit, or less, both 78 and 81 degrees Fahrenheit would be “approximately common” with 80 degrees Fahrenheit. Other manufacturing tolerance ranges will be obvious to those of ordinary skill in the art having the benefit of this disclosure in view of their electronic components, design considerations, operational environment, and so forth.

In one embodiment, in addition to detecting an approximately common temperature, embodiments of the disclosure detect an approximately static temperature occurring at the first location or the second location during a predetermined temperature measurement interval, such as about one minute. The approximately static temperature means that the temperature is not quickly changing, as would be the case when a user was touching various surfaces with their hand, which would cause rapid heating and cooling.

In one embodiment, in addition to detecting the approximately common temperature and the approximately static temperature across a predetermined temperature measurement interval, a light sensor further detects a dark environment. For example, the light sensor may detect that an intensity of received ambient light is below a predefined luminous intensity threshold, which would indicate that the electronic device was in a relatively dark environment. Similarly, a touch sensor can determine that there is an absence of touch sensor actuation along a housing of the electronic device. Further, a motion sensor can detect an approximate rotational stability of the electronic device, i.e., the motion sensor can determine that no serious rotations are occurring as would be the case where the electronic device was in a hand while a user was walking, was being passed between a user's hands, was being lifted from a table to a user's ear, and so forth, each of which would cause the electronic device to experience rotational change. In one embodiment, when these various conditions are detected, one or more processors of the electronic device detect an in-repository container condition.

When an in-repository container condition is detected, in one or more embodiments the one or more processors can perform a control operation. Illustrating by a simple example, in one embodiment the control operation comprises monitoring a motion sensor. Embodiments of the disclosure contemplate that a user may be unaware of whether their smartphone, for example, is disposed within a repository container. Consequently, executing a control operation that monitors a motion sensor provides a simple way for the user to check. In one embodiment, when a user taps or double taps on the purse from the exterior of the repository container, the one or more processors can detect this predefined motion this with the motion sensor.

In one embodiment, upon detecting the predefined motion, the one or more processors can deliver, with an output device, a notification that the electronic device is disposed within the purse. This notification can be serious, whimsical, or take other forms. For instance, a user may double-tap on the exterior of a purse, the one or more processors might cause an audible message to be delivered by the output device such as, “I love playing hide and seek” or “you're getting warmer” or “hey, you found me—I've missed you.” Other notifications will be obvious to those of ordinary skill in the art having the benefit of this disclosure.

In another embodiment, when the in-repository container condition is detected, the control operation can comprise increasing a volume of an audio output device. Embodiments of the disclosure contemplate that a ringer or other audible notification may become muted when an electronic device is disposed within a repository container. Accordingly, in one embodiment the control operation can comprise placing any audio output devices into a “loud ring” or other elevated volume condition.

In another embodiment, when the in-repository container condition is detected, the control operation can comprise sending an automatic reply message in response to receiving an incoming communication from a remote electronic device. For example, if the electronic device receives a text message while in a purse, the one or more processors may send a reply message letting the sender of the original communication know that the recipient may be unavailable or that the recipient will contact the sender at a later time. In one or more embodiments, the reply message is user definable. In one embodiment a user can define the message to be sent as the automatic reply. In other embodiments, the content can change as a function of time or other factors.

In another embodiment, the control operation can again comprise monitoring a motion sensor. If the one or more processors determine with the motion detector that the repository container is stationary, the one or more processors may conclude that a user is away from the repository container and any incoming communication notification may be unheard or missed. Accordingly, the one or more processors can monitor the motion sensor to determine when the user moves the repository container. When this occurs, in one embodiment the one or more processors deliver again an announcement or alert of the received communication. In one or more embodiments, the rebroadcast of this alert is louder so that the user can hear it.

In addition to determining when an electronic device is disposed within a repository container, embodiments of the disclosure can determine when the repository container is opened. This can be accomplished in a number of optional ways. In one embodiment, when the repository container is opened the intensity of received ambient light transitions above the predefined threshold due to an inrush of light. In another embodiment, the ambient temperature increases above a predefined temperature threshold due to the fact that a user's hand or other thermally emissive object enters the repository container. In another embodiment, one or more proximity sensor components can detect a portion of a user, e.g., a hand, moving within a predefined thermal radius of the electronic device. Other techniques will be obvious to those of ordinary skill in the art having the benefit of this disclosure.

In one or more embodiments, when an open-repository container condition is detected, the one or more processors can perform another control operation. As with the first control operation, the second control operation can take any of a variety of forms. For example, where the control operation comprised increasing the volume of an audio output device, the other control operation can comprise reducing the volume of the audio output device. In another embodiment, the second control operation can comprise activating a vibration mode so the user may feel the device when their hand is disposed within the repository container.

In another embodiment, when the one or more processors detect that the repository container is being opened they can deliver a notification that the electronic device is disposed within the purse. This notification may be fun and whimsical, such as “I love playing hide and seek.” Alternatively, the notification may be simpler, such as a beep or tone. Other notifications will be obvious to those of ordinary skill in the art having the benefit of this disclosure.

Other control operations can be more complex. For instance, the other control operation can comprise monitoring one or more proximity sensor components. They can detect a thermal object, such as the user's hand, approaching the electronic device once the object is within a thermal reception radius. In one embodiment, when a hand or other warm object is approaching, the one or more processors may cause an audio output device to sound a sonar type alert. This alert can be a function of distance, i.e., it can change pitch/pattern/level/type as the object gets closer to the electronic device. This allows a user to converge to the electronic device location without looking.

In another embodiment, when the repository container is opened or a thermal object approaches the electronic device, the one or more processors may deliver—with an output device—an alert of missed messages for the first time. In another embodiment, the other control operation can include monitoring a motion sensor. For example, if the repository container is a purse, and an in-purse and open-purse condition is detected while the purse is moving, e.g., in a car, the one or more processors may redirect incoming communications to a companion device such as the vehicle's audio system or a companion wearable device via a near-field wireless communication protocol. Other control operations will be obvious to those of ordinary skill in the art having the benefit of this disclosure.

Advantageously, embodiments of the disclosure can quickly and accurately determine encapsulation by a repository container so that the device can perform one or more control operations in response. Embodiments of the disclosure are further capable of distinguishing this in-repository container state from other conditions, such as when a user lifts an electronic device to their face. Embodiments of the disclosure provide a natural, immediate, and intuitive manner of controlling an electronic device without the need to deliver voice commands or touch input to a user interface.

In one embodiment an electronic device includes at least a light sensor, a touch sensor, and one or more proximity sensors. The one or more proximity sensors can each include an infrared receiver to receive infrared thermal emissions from a thermal object disposed external to the housing. Accordingly, the one or more proximity sensors function as thermal sensors to detect heat from a thermal object such as a user's body or hand.

In one embodiment, one or more processors operable with the sensors can detect background conditions using the sensors to conclude that the electronic device is disposed within a repository container. For example, the one or more processors can detect an intensity of received ambient light is below a predetermined threshold to determine that the electronic device is disposed within the repository container. Similarly, the one or more processors can determine that a user is not actively touching a housing or user interface of the electronic device. This is referred to as detecting the “absence of touch sensor actuation” with the touch sensor.

As will be described in more detail below, the “absence of touch sensor actuation” is a novel and innovative concept used to determine an in-repository container condition. Embodiments of the disclosure contemplate that modern electronic devices can include many different types of sensors. For example, embodiments of the present disclosure include touch sensors, which may be capacitive touch sensors, and that may be placed at various locations along the housing of an electronic device. While capacitive touch sensors can be used in one embodiment, mechanical touch sensors, resistive touch sensors, and other types of touch sensors can be used as well. Those of ordinary skill in the art understand that touch sensors are used to detect the positive state, i.e., touch, to detect user presence, user input, and other conditions. However, embodiments of the disclosure employ the innovative use of the negative condition, i.e., an active touch sensor that is awaiting touch input, but that does not receive the same within a predetermined sensor read time. This is known as an absence of touch sensor actuation. Advantageously, embodiments of the disclosure uniquely employ this corollary state as a factor in concluding that an electronic device is disposed within a repository container. As used herein, detecting the “absence of touch sensor actuation” is used to refer to a touch sensor that is in an active state that can receive touch input, but that fails to receive any touch input from a user's skin, within a predetermined sensor read time. Examples of these predetermined sensor read times range from a few milliseconds to several seconds.

In one embodiment, the one or more processors can further determine that a temperature at both a first location on the electronic device and a second location on the electronic device is an approximately common temperature. As used herein, an “approximately common” temperature refers to a temperature that is within a predetermined range. Said differently, a temperature at a first location of the electronic device would be approximately common with a temperature at a second location of the electronic device, in one embodiment, when a difference between the temperatures at each end was within plus or minus two degrees Fahrenheit, for example. Moreover, the term “approximately” is used to refer to an amount that does not have to be absolute, but can include some designed tolerance. For example, 79.378 degrees Fahrenheit or 80.125 degrees Fahrenheit could be “approximately” 80 degrees Fahrenheit when including the tolerances of mechanical and electrical systems and sensors. This distinguishes in-repository container conditions from conditions in which a user is holding the device, wherein portions of the housing adjacent to a user's hand would be significantly warmer than other portions of the housing. While plus or minus two degrees Fahrenheit is one explanatory range constituting “approximately common” temperatures, others will be readily apparent to those of ordinary skill in the art having the benefit of this disclosure.

In one embodiment, when the one or more processors determine that the intensity of ambient light is below a predetermined threshold, there is no touch input being delivered to the touch sensor, and there is approximately the same temperature at two different locations of the device, the one or more processors can conclude that the electronic device is disposed within a repository container. The one or more processors can optionally additionally detect that a motion of an electronic device defined by parametric data indicates an approximate rotational stability of the electronic device to determine the in-repository container condition as well. In one or more embodiments the one or more processors can execute a control operation in response to the electronic device being disposed within the repository container.

In addition to the three factors set forth above, other inputs from other sensors can be used to confirm with greater certainty that the electronic device is, for example, situated within a repository container rather than simply placed within a drawer. For example, in one embodiment the one or more proximity sensors can confirm that the approximately common temperature is not changing quickly, i.e., is an approximately static temperature at the first location or the second location during a predetermined measurement interval such as one minute. Other sensor information used to determine in-purse conditions will be obvious to those of ordinary skill in the art having the benefit of this disclosure.

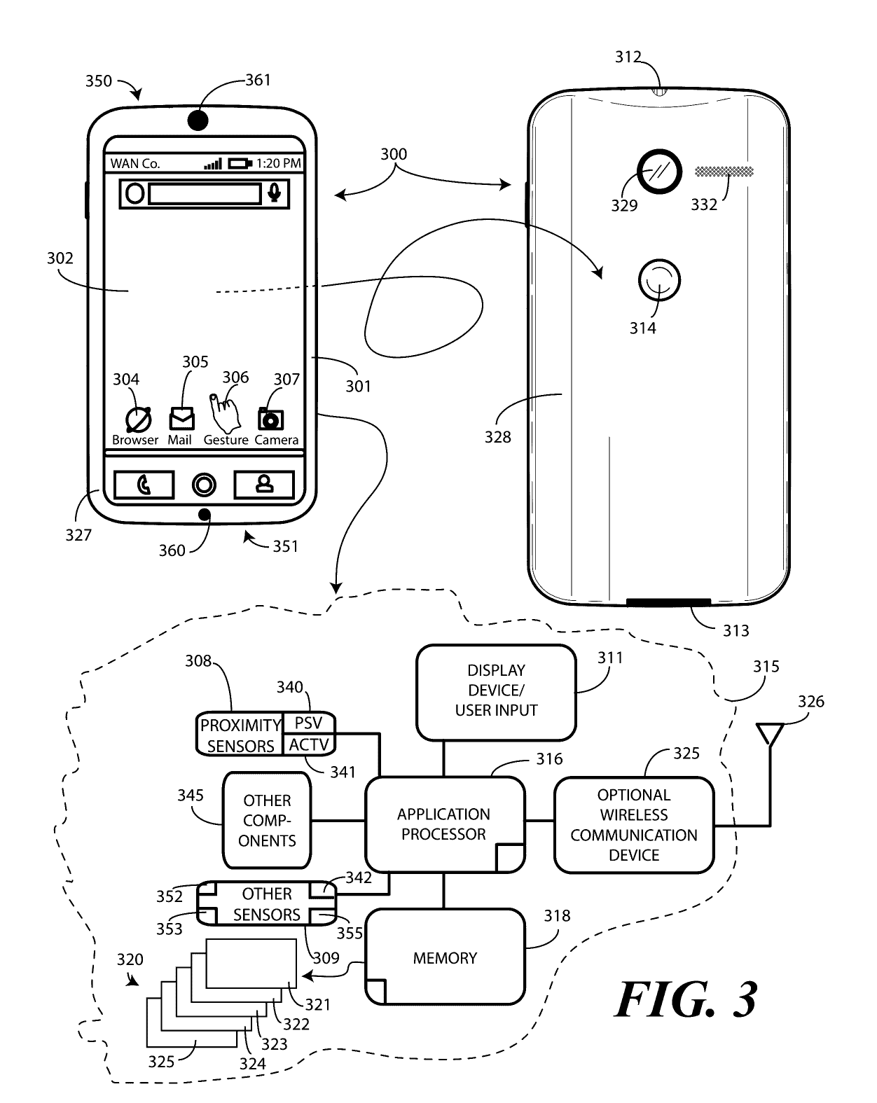

Turning now to FIG. 3, illustrated therein is one explanatory electronic device 300 configured in accordance with one or more embodiments of the disclosure. The electronic device 300 of FIG. 3 is a portable electronic device, and is shown as a smart phone for illustrative purposes. However, it should be obvious to those of ordinary skill in the art having the benefit of this disclosure that other electronic devices may be substituted for the explanatory smart phone of FIG. 3. For example, the electronic device 300 could equally be a conventional desktop computer, palm-top computer, a tablet computer, a gaming device, a media player, or other device suitable for placement within a repository container, such as the purse (101) of FIG. 1 above.

This illustrative electronic device 300 includes a display 302, which may optionally be touch-sensitive. In one embodiment where the display 302 is touch-sensitive, the display 302 can serve as a primary user interface of the electronic device 300. Users can deliver user input to the display 302 of such an embodiment by delivering touch input from a finger, stylus, or other objects disposed proximately with the display. In one embodiment, the display 302 is configured as an active matrix organic light emitting diode (AMOLED) display. However, it should be noted that other types of displays, including liquid crystal displays, would be obvious to those of ordinary skill in the art having the benefit of this disclosure.

The explanatory electronic device 300 of FIG. 3 includes a housing 301. In one embodiment, the housing 301 includes two housing members. A front housing member 327 is disposed about the periphery of the display 302 in one embodiment. A rear-housing member 328 forms the backside of the electronic device 300 in this illustrative embodiment and defines a rear major face of the electronic device. Features can be incorporated into the housing members 327,328. Examples of such features include an optional camera 329 or an optional speaker port 332, which are show disposed on the rear major face of the electronic device 300 in this embodiment. In this illustrative embodiment, a user interface component 314, which may be a button or touch sensitive surface, can also be disposed along the rear-housing member 328. These features are shown being disposed on the rear major face of the electronic device 300 in this embodiment, but could be located elsewhere, such as on the front major face in other embodiments.

In one embodiment, the electronic device 300 includes one or more connectors 312,313, which can include an analog connector, a digital connector, or combinations thereof. In this illustrative embodiment, connector 312 is an analog connector disposed on a first end 350, i.e., the top end, of the electronic device 300, while connector 313 is a digital connector disposed on a second end 351 opposite the first end 350, which is the bottom end in this embodiment.

A block diagram schematic 315 of the electronic device 300 is also shown in FIG. 3. In one embodiment, the electronic device 300 includes one or more processors 316. In one embodiment, the one or more processors 316 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 300. Each of the application processor and the auxiliary processor(s) can be configured to process and execute executable software code to perform the various functions of the electronic device 300. A storage device, such as memory 318, can optionally store the executable software code used by the one or more processors 316 during operation.

In this illustrative embodiment, the electronic device 300 also includes a communication circuit 325 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 325 may also utilize wireless technology for communication, such as, but are not limited to, peer-to-peer or ad hoc communications such as HomeRF, Bluetooth and IEEE 802.11 (a, b, g, or n), and other forms of wireless communication such as infrared technology. The communication circuit 325 can include wireless communication circuitry, one of a receiver, a transmitter, or transceiver, and one or more antennas 326.

In one embodiment, the one or more processors 316 can be responsible for performing the primary functions of the electronic device 300. For example, in one embodiment the one or more processors 316 comprise one or more circuits operable with one or more user interface devices 311, which can include the display 302, to present presentation information to a user. The executable software code used by the one or more processors 316 can be configured as one or more modules 320 that are operable with the one or more processors 316. Such modules 320 can store instructions, control algorithms, logic steps, and so forth.

In one embodiment, the one or more processors 316 are responsible for running the operating system environment 321. The operating system environment 321 can include a kernel 322 and one or more drivers, and an application service layer 323, and an application layer 324. The operating system environment 321 can be configured as executable code operating on one or more processors or control circuits of the electronic device 300.

The application layer 324 can be responsible for executing application service modules. The application service modules may support one or more applications or “apps.” Examples of such applications shown in FIG. 3 include a cellular telephone application 303 for making voice telephone calls, a web browsing application 304 configured to allow the user to view webpages on the display 302 of the electronic device 300, an electronic mail application 305 configured to send and receive electronic mail, a gesture application 306 configured to detect gesture actions with one or more proximity detector components 341 from a user near or along the electronic device 300, and a camera application 307 configured to capture still (and optionally video) images.

These applications are illustrative only, as others will be obvious to one of ordinary skill in the art having the benefit of this disclosure. The applications of the application layer 324 can be configured as clients of the application service layer 323 to communicate with services through application program interfaces (APIs), messages, events, or other inter-process communication interfaces. Where auxiliary processors are used, they can be used to execute input/output functions, actuate user feedback devices, and so forth.

In one embodiment, one or more proximity sensors 308 can be operable with the one or more processors 316. In one embodiment, the one or more proximity sensors 308 include one or more proximity sensor components 340. The proximity sensors 308 can also include one or more proximity detector components 341. In one embodiment, the proximity sensor components 340 comprise only signal receivers. By contrast, the proximity detector components 341 include a signal receiver and a corresponding signal transmitter.

While each proximity detector component 341 can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components 341 comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components 341 can have signal receivers that receive similar wavelengths, i.e., about 860 nanometers.

In one or more embodiments the proximity sensor components 340 have a longer detection range than do the proximity detector components 341 due to the fact that the proximity sensor components detect heat directly emanating from a thermal object such as a person's body (as opposed to reflecting off the person's body) while the proximity detector components rely upon reflections of infrared light emitted from the signal transmitter. For example, the proximity sensor component 340 may be able to detect a thermal object such as a person's body via emitted heat from a distance of about ten feet, while the signal receiver of the proximity detector component 341 may only be able to detect reflected signals from the transmitter at a distance of about one to two feet.

In one embodiment, the proximity sensor component 340 comprises an infrared signal receiver so as to be able to detect infrared emissions from a thermal object such as a person or a portion of a person. Accordingly, the proximity sensor component 340 requires no transmitter since objects disposed external to the housing deliver emissions that are received by the infrared receiver. As no transmitter is required, each proximity sensor component 340 can operate at a very low power level. Evaluations conducted show that a group of infrared signal receivers can operate with a total current drain of just a few microamps (˜10 microamps per sensor). By contrast, a proximity detector component 341, which includes a signal transmitter, may draw hundreds of microamps to a few milliamps.

In one embodiment, one or more proximity detector components 341 can each include a signal receiver and a corresponding signal transmitter. The signal transmitter can transmit a beam of infrared light that reflects from a nearby object and is received by a corresponding signal receiver. The proximity detector components 341 can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals. The reflected signals can also be used to receive user input from a user delivering touch or gesture input to the electronic device 300.

In one embodiment, the one or more processors 316 may generate commands or execute control operations based on information received from one or more proximity sensors 308. The one or more processors 316 may also generate commands or execute control operations based upon information received from a combination of the one or more proximity sensors 308 and one or more other sensors 309. Alternatively, the one or more processors 316 can generate commands or execute control operations based upon information received from the one or more other sensors 309 alone. Moreover, the one or more processors 316 may process the received information alone or in combination with other data, such as the information stored in the memory 318.

The one or more other sensors 309 may include a microphone 360, an earpiece speaker 361, a second loudspeaker (disposed beneath speaker port 332), and a user interface component 314 such as a button. The one or more other sensors 309 may also include key selection sensors, a touch pad sensor, a touch screen sensor, a capacitive touch sensor, and one or more switches. Touch sensors 355 may used to indicate whether any of the user actuation targets present on the display 302 are being actuated. Alternatively, touch sensors 355 disposed in the housing 301 can be used to determine whether the electronic device 300 is being touched at side edges or major faces of the electronic device 300 are being performed by a user. The touch sensors 355 can include surface and/or housing capacitive sensors in one embodiment. The other sensors 309 can also include audio sensors and video sensors (such as a camera).

The other sensors 309 can also include motion sensors 342, such as one or more accelerometers 352 or gyroscopes 353. For example, an accelerometer 352 may be embedded in the electronic circuitry of the electronic device 300 to show vertical orientation, constant tilt and/or whether the electronic device 300 is stationary. The measurement of tilt relative to gravity is referred to as “static acceleration,” while the measurement of motion and/or vibration is referred to as “dynamic acceleration.” A gyroscope 353 can be used in a similar fashion.

The accelerometer 352 or gyroscope 353 can be included to detect motion of the electronic device 300 as well. Additionally, the accelerometer 352 or gyroscope 353 can be used to sense some of the gestures of the user. The accelerometer 352 or gyroscope 353 can also be used to determine the spatial orientation of the electronic device 300 as well in three-dimensional space by detecting a gravitational direction. In addition to, or instead of, the accelerometer 352 or gyroscope 353, an electronic compass can be included to detect the spatial orientation of the electronic device 300 relative to the earth's magnetic field.

Regardless of the type of motion sensors 342 that are used, in one embodiment the motion sensors 342 are also operable to detect movement, and direction of movement, of the electronic device 300 by a user. In one or more embodiments, the other sensors 309 and the motion sensors 342 can each be used to detect motion corresponding to that of a repository container, a user's body, or to human motion of a hand. This information can be used to determine that the electronic device 300 is proximately located with a user's body.

Illustrating by example, in one embodiment the motion sensors 342 can detect parametric data corresponding to motion of the electronic device 300. When the electronic device 300 is placed within a repository container such as a purse (101), the motion sensors 342 can determine that this detected parametric data correspond to approximate rotational stability since the electronic device 300 is likely to remain in a relatively constant position within the repository container. This is in contrast to when the electronic device 300 is in a user's hand and is undergoing many rotations about various axes. When in a repository container, the electronic device 300 may experience small motions, such as vibration, shaking, bouncing, micromotions, and so forth. However, the electronic device 300 is unlikely to rotate about an axis and will therefore experience approximate rotational stability. The one or more processors 316 can then extract parametric data from electronic signals delivered by these motion sensors 342 in response to the electronic device's motion within the repository container. By comparing the parametric data to a reference file stored in memory 318, the one or more processors 316 can identify approximate rotational stability. The one or more processors 316 can use this information to distinguish the electronic device 300 being in a repository container compared to, for example, being in a user's hand. Other user motion that can be readily detected by parametric data includes motion associated with driving, riding a bike, or simply shifting in their seat. In one or more embodiments, the one or more processors 316 can conclude from these motions that the electronic device 300 is moving, either while in a repository container or outside of the repository container.

Many of the sensors in the electronic device 300 can be used to detect movement, gestures, or other user input. For example, the one or more proximity sensors 308 can detect the gesture of a user waving a hand above the display 302. In another embodiment, the user can deliver gesture input by touching the display 302. In yet another embodiment, the accelerometer 352 can detect gesture input from a user lifting, shaking, or otherwise deliberately moving the electronic device 300. In yet other embodiments, the user can deliver gesture input by rotating or changing the orientation of the electronic device 300, which can be detected by multiple accelerometers 352 or a gyroscope 353.

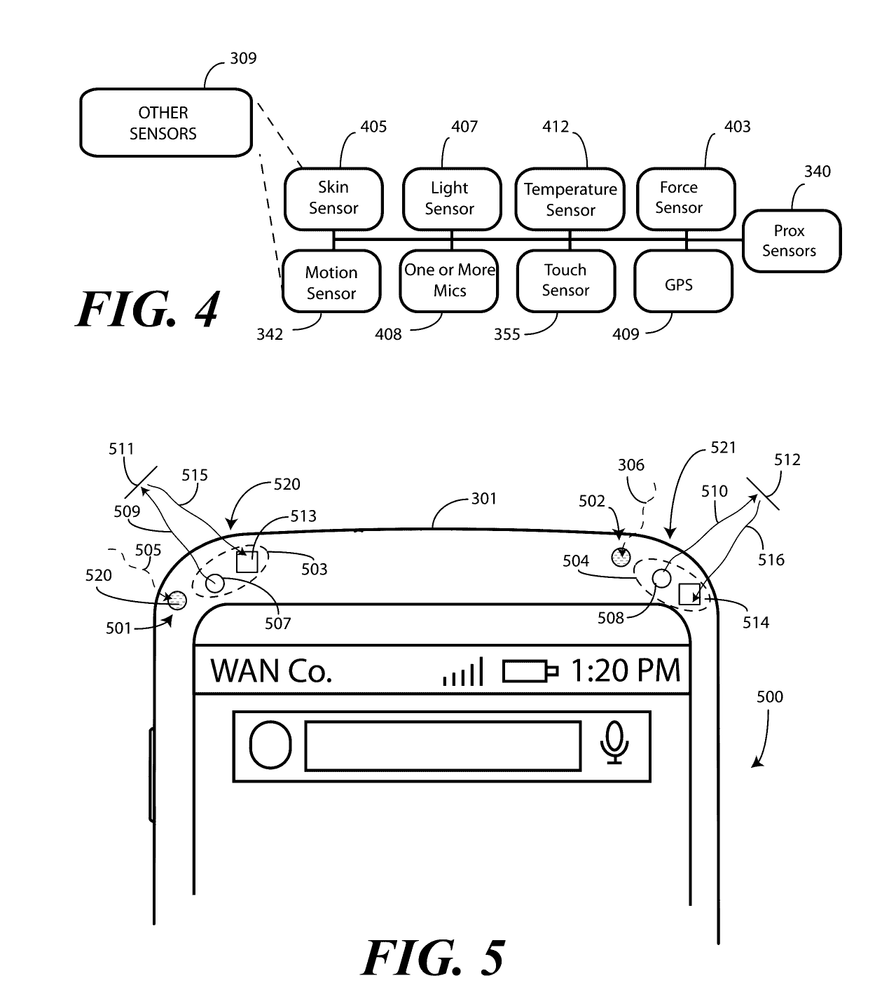

It should be clear to those of ordinary skill in the art having the benefit of this disclosure that additional sensors can be included with the other sensors 309 shown in FIG. 3. Turning briefly to FIG. 4, illustrated therein are some additional sensors that can be operable with the one or more processors (316) as well. In one or more embodiments, many of these other sensors 309 are environmental sensors to detect environmental conditions about the electronic device (300). General examples of these sensors include time sensors, date sensors, environmental sensors, weather sensors, ultrasonic sensors, location sensors, and so forth.

In one embodiment, a skin sensor 405 is configured to determine when the electronic device (400) is touching the skin of a person. For example, when the electronic device (300) is being held within the hand of a user, this can be detected by the skin sensor 405. The skin sensor 405 can include a substrate with an electrode disposed thereon. The electrode can confirm the object touching the skin sensor 405 is skin by detecting electrical signals generated by a heartbeat in one embodiment. Other forms of skin sensors will be obvious to those of ordinary skill in the art having the benefit of this disclosure.

A touch sensor 355 can be operable with, or in place of, the skin sensor 405. The touch sensor 355 can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors (316), to detect an object in close proximity with—or touching—the surface of the display (302) or the housing (301) of the electronic device (300) by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

The force sensor 403 can be included. The force sensor 403 can take various forms. For example, in one embodiment, the force sensor 403 comprises resistive switches or a force switch array configured to detect contact with either the display (302) or the housing (301) of the electronic device (300). An “array” refers to a set of at least one switch. The array of resistive switches can function as a force-sensing layer, in that when contact is made with either the surface of the display (302) or the housing (301) of the electronic device (300), changes in impedance of any of the switches may be detected. The array of switches may be any of resistance sensing switches, membrane switches, force-sensing switches such as piezoelectric switches, or other equivalent types of technology. In another embodiment, the force sensor 403 can be capacitive. In yet another embodiment, piezoelectric sensors can be configured to sense force as well. For example, where coupled with the lens of the display (302), the piezoelectric sensors can be configured to detect an amount of displacement of the lens to determine force. The piezoelectric sensors can also be configured to determine force of contact against the housing (301) of the electronic device (300) rather than the display (302).

A temperature sensor 412 can be configured to monitor the temperature of the environment. A light sensor 407 can be used to detect whether or not ambient light is incident on the housing (301) of the electronic device (300). The light sensor 407 can also be used to detect an intensity of ambient light is above or below a predefined threshold. In one or more embodiments the light sensor 407 can detect changes in optical intensity, color, light, or shadow in the near vicinity of the electronic device (300). This can be used to make inferences about whether the electronic device (300) is disposed within a repository container as well. For example, if the light sensor 407 detects low-light conditions, i.e., when the intensity of received ambient light is below a predefined threshold, this can indicate that the electronic device (300) is disposed within a repository container. In one embodiment, the light sensor 407 can be configured as an image-sensing device that captures successive images about the device and compares luminous intensity, color, or other spatial variations between images to detect weather conditions.

One or more microphones 408 can be included to receive acoustic input. While the one or more microphones 408 can be used to sense voice input, voice commands, and other audio input, in one or more embodiments they can be used as environmental sensors to sense environmental sounds such as rumpling of soft surfaces of repository containers encapsulating the electronic device (300) Alternatively, the one or more microphones 408 can be used to detect the nearby presence of items stowed in a repository container, such as the coins (201), medications (202), grooming items, notecards (204), keys (205), lotions (206), notepads (207), lip balm (208), and other items disposed within the purse (101) of FIG. 2. Accordingly, an in-repository container condition can be inferred from acoustic data captured by the one or more microphones 408 in one or more embodiments.

In one embodiment, the one or more microphones 408 include a single microphone. However, in other embodiments, the one or more microphones 408 can include two or more microphones. Where multiple microphones are included, they can be used for selective beam steering to, for instance, determine from which direction a sound emanated. If the electronic device (300) is in a repository container such as a purse (101), detected sound could be coming from the sides of the repository container or the contents disposed therein. The ability to steer the beams toward the pocket opening allows the one or more processors (316) to determine with more precision whether the electronic device (300) is disposed within the repository container in one or more embodiments.

Illustrating by example, a first microphone can be located on a first side of the electronic device (300) for receiving audio input from a first direction, while a second microphone can be placed on a second side of the electronic device (300) for receiving audio input from a second direction. The one or more processors (316) can then select between the first microphone and the second microphone to beam steer audio reception in a particular direction. Alternatively, the one or more processors (316) can process and combine the signals from two or more microphones to perform beam steering.

In one or more embodiments, the one or more processors (316) may require location information of the electronic device (300), such as to know whether the electronic device (300) is in a car. Accordingly, in one embodiment a global positioning system device 409 can be included for determining a location and/or movement of the electronic device (300). In one or more embodiments, the global positioning system device 409 is configured for communicating with a constellation of earth orbiting satellites or a network of terrestrial base stations to determine an approximate location. While a global positioning system device 409 is one example of a location determination device, it will be clear to those of ordinary skill in the art having the benefit of this disclosure that other location determination devices, such as electronic compasses or gyroscopes, could be used as well.

A proximity detector component 341 can emit infrared signals to determine when the electronic device (300) is covered by an object such as the sides of a repository container or the items disposed therein. Other sensors, subsets of these sensors, and so forth can be used in accordance with the methods described herein.

These other sensors 309 can be used to confirm the electronic device (300) is disposed within a repository container in one or more embodiments. Said differently, when the one or more processors (316) determine that an intensity of received ambient light is below a predefined threshold, an absence of touch sensor actuation occurs along a housing of the electronic device (300), and an approximately common temperature occurring at both a first location of the electronic device and a second location of the electronic device (300), the one or more processors (316) conclude that the electronic device (300) is disposed within a repository container such as a purse (101) or suitcase.

The one or more of these other sensors 309 can be used to confirm this conclusion in one or more embodiments. For example, the motion sensor 342 may confirm that motion of the electronic device (300) defined by parametric data from the motion sensor 342 indicates an approximate rotational stability of the electronic device (300), thereby confirming that the electronic device (300) is covered by one or more sides of the repository container. The microphone 408 may detect the sound of textile material, leather, or synthetic materials as the electronic device (300) slides into the repository container. The skin sensor 405 may detect that no skin is touching the housing (301). The proximity detector component 341 may determine that the electronic device (300) is covered. The temperature sensor 411 can be used to determine that the approximately static temperature occurring at the first location and the second location of the electronic device remains during a predetermined temperature measurement interval, such as thirty seconds or a minute. These each can provide a confirmation of the in-repository container condition, and can be used alone or in combination with other factors.

Turning now back to FIG. 3, other components 345 operable with the one or more processors 316 can include output components such as video outputs, audio outputs, and/or mechanical outputs. Examples of output components include audio outputs such as speaker port 332, earpiece speaker 361, or other alarms and/or buzzers and/or a mechanical output component such as vibrating or motion-based mechanisms. Still other components will be obvious to those of ordinary skill in the art having the benefit of this disclosure.

The other components 345 can also include a motion generation device for providing haptic notifications or vibration notifications to a user. For example, a piezoelectric transducer, rotational motor, or other electromechanical device can be configured to impart a force or vibration upon the housing 301 of the electronic device 300 to provide a thump, bump, vibration, or other physical sensation to the user. The inclusion of the motion generation device, in one embodiment, allows either audible or tactile feedback to be delivered when, for example, the one or more proximity sensors 308 detect a user's hand within a predefined thermal radius. Accordingly, a user may “stick” their hand into a purse, which causes the motion generation device to vibrate. This provides a quick and easy way for the person to find the electronic device 300 in a purse without looking. The one or more processors 316 can be configured to actuate the motion generation device to deliver a tactile or vibration output alone or in combination with other outputs such as audible outputs.

In one or more embodiments, the one or more processors 316 are operable to detect motion of the electronic device 300. In one embodiment, the accelerometer 352 serves as a motion detector operable with the one or more processors 316. A gyroscope 353 then serves as another motion detector operable with the one or more processors 316. Where a gyroscope 353 is not included with the electronic device 300, multiple accelerometers can substitute for the gyroscope 353 to determine rotation of the electronic device 300 about the axis. In such an embodiment, the accelerometer 352 would serve as the motion detector while the accelerometer 352 and another accelerometer substitute for the gyroscope 353. This results in the other motion detector having an accelerometer 352 in common with the motion detector.

It is to be understood that FIG. 3 is provided for illustrative purposes only and for illustrating components of one electronic device 300 in accordance with embodiments of the disclosure, and is not intended to be a complete schematic diagram of the various components required for an electronic device. Therefore, other electronic devices in accordance with embodiments of the disclosure may include various other components not shown in FIG. 3, or may include a combination of two or more components or a division of a particular component into two or more separate components, and still be within the scope of the present disclosure.

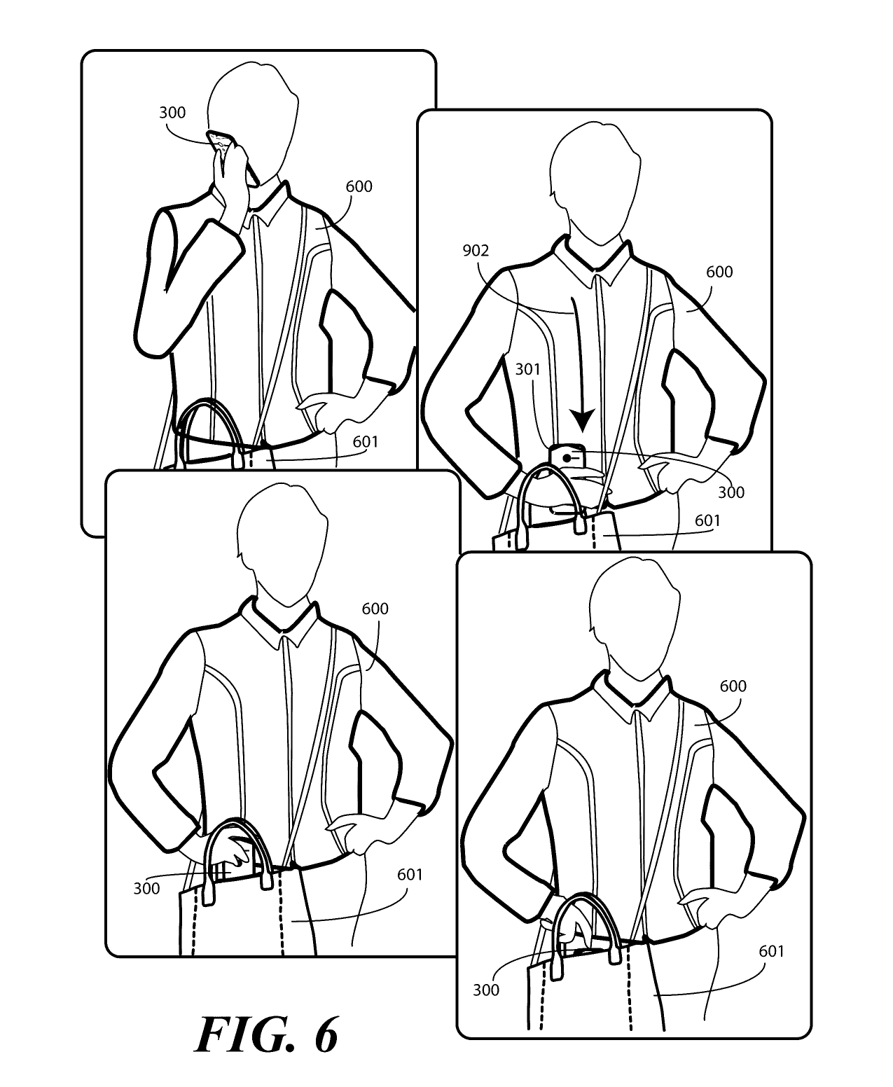

Turning now to FIG. 5, illustrated therein is the difference between proximity sensor components 501,502 and proximity detector components 503,504 as those terms are used herein. Illustrated therein are two proximity sensor components 501,502 and two proximity detector components 503,504, each disposed at different locations 520,521, each of which happens to be a corner of the electronic device 300 in this illustrative embodiment. In this embodiment, each proximity sensor component 501,502 comprises a signal receiver 513 only, such as an infrared photodiode to detect an infrared emission 505,506 from an object external to the housing 301 of the electronic device 300. No corresponding transmitter is included or required for the proximity sensor component 501,502 to function. As no active transmitter emitting signals is included, each proximity sensor component 501,502 is sometimes referred to as a “passive IR” proximity sensor. As the proximity sensor components 501,502 receive thermal emissions from an object, in one or more embodiments they can be used as temperature sensors.

By contrast, each proximity detector component 503,504 can be an infrared proximity sensor set that uses a signal emitter 507,508 that transmits a beam 509,510 of infrared light that reflects 511,512 from a nearby object and is received by a corresponding signal receiver 513,514. Proximity detector components 503,504 can be used, for example, to compute the distance to any nearby object from characteristics associated with the reflected signals 515,516. The reflected signals 515,516 are detected by the corresponding signal receiver 513,514, which may be an infrared photodiode used to detect reflected light emitting diode (LED) light, respond to modulated infrared signals, and/or perform triangulation of received infrared signals. Accordingly, the proximity detector components 503,504 can be used to determine of the electronic device 300 is covered by clothing in one or more embodiments.

In one embodiment, the proximity sensor components 501,502 and the proximity detector components 503,504 can include at least two sets of components. For example, a first set of components can be disposed at a location 520 on the electronic device 300, while another set of components can be disposed at a second location 521 on the electronic device 300.

Now that the various hardware components have been described, attention will be turned to methods and use cases in accordance with one or more embodiments of the disclosure. Turning now to FIG. 6, a user 600 is shown placing the electronic device 300 within a repository container, which in this illustrative example is her purse 601. For ease of illustration, the example of a repository container used in the examples below will be that of a purse 601. However, as noted above, embodiments of the disclosure are not so limited. Repository containers can include briefcases, satchels, duffel bags, suitcases, handbags, backpacks, shoulder bags, clutches, computer bags, attaché cases, messenger bags, and so forth. Other examples of repository containers will be obvious to those of ordinary skill in the art having the benefit of this disclosure.

The movement 602 used to place the electronic device 300 in the purse 601 has associated therewith a velocity and acceleration. In one embodiment the one or more processors (316) can determine, with the motion sensor (342) whether the movement 602 and/or motion profile, which can include velocity and acceleration, duration, and the stopping of the motion occurring during the movement 602 exceeds a predetermined threshold. In one embodiment, a predetermined acceleration threshold is about 0.5 meters per second square net of gravity. Embodiments of the disclosure contemplate that the user 600 will take care to ensure that the electronic device 300 is safely placed within the purse 601. Accordingly, the movement 602 will be slow and deliberate. By confirming that characteristics of the movement, such as velocity and acceleration are below a predefined threshold, this can serve as an additional confirmation of the in-purse condition.

In one or more embodiments, the acceleration determination can be used in other ways as well. First, it can be used to confirm that the movement 602 moving the electronic device 300 occurred with the gravity direction, i.e., downward, as would be the case when placing the electronic device 300 in a purse 601, but not when raising the electronic device 300 to the user's ear. Second, by comparing the acceleration to a predetermined threshold, the acceleration can be used to confirm that a user is actually placing the electronic device 300 in a purse 601 rather than performing some other operation, such as waving the electronic device 300 around. Other uses for the acceleration data will be obvious to those of ordinary skill in the art having the benefit of this disclosure. Illustrating by example, the one or more processors (316) can compare the movement 602 to the gravity direction. For example, in one embodiment the one or more processors can determine whether at least some of the movement 602 was with the gravity direction. This step can ensure that the electronic device 300 is going into the purse 601 and not being carried by the user 600.

In one embodiment, a method for controlling the electronic device 300 includes detecting, with one or more sensors, that the electronic device 300 is disposed within a repository container such as the purse 601 as a function of at least an intensity of received ambient light being below a predefined threshold, an absence of touch sensor actuation along a housing 301 of the electronic device, and an approximately common temperature occurring at both a first location and a second location along the electronic device 300. The motion sensor (342) can detect the motion of the electronic device 300, while the touch sensor (355) can detect the absence of touch sensor actuation. A light sensor (407) can detect the intensity of received ambient light, and either one or more proximity sensors (308) or a temperature sensor (412) can determine the approximately common temperature.

Other factors of the function of detecting that the electronic device 300 is disposed within the repository container include motion of the electronic device 300 being defined by parametric data indicating that the electronic device 300 is experiencing an approximate rotational stability. The motion sensor (342) can detect this approximate rotational stability. Additionally, the function can be of an approximately static temperature occurring at the first location or the second location during a predetermined temperature measurement interval. Other factors will be obvious to those of ordinary skill in the art having the benefit of this disclosure. Advantageously, embodiments of the disclosure can detect this in-container condition simply, quickly, and accurately. In one embodiment, using a motion sensor (342), a touch sensor (355), and a temperature sensor (411), or alternatively one or more proximity sensor components (340), one or more processors (316) of the electronic device 300 detect one or more conditions to determine that the electronic device 300 is disposed within the repository container, e.g., purse 601. Once one or more processors (316) detect that the electronic device 300 is disposed within the repository container, the one or more processors (316) can perform a control operation.

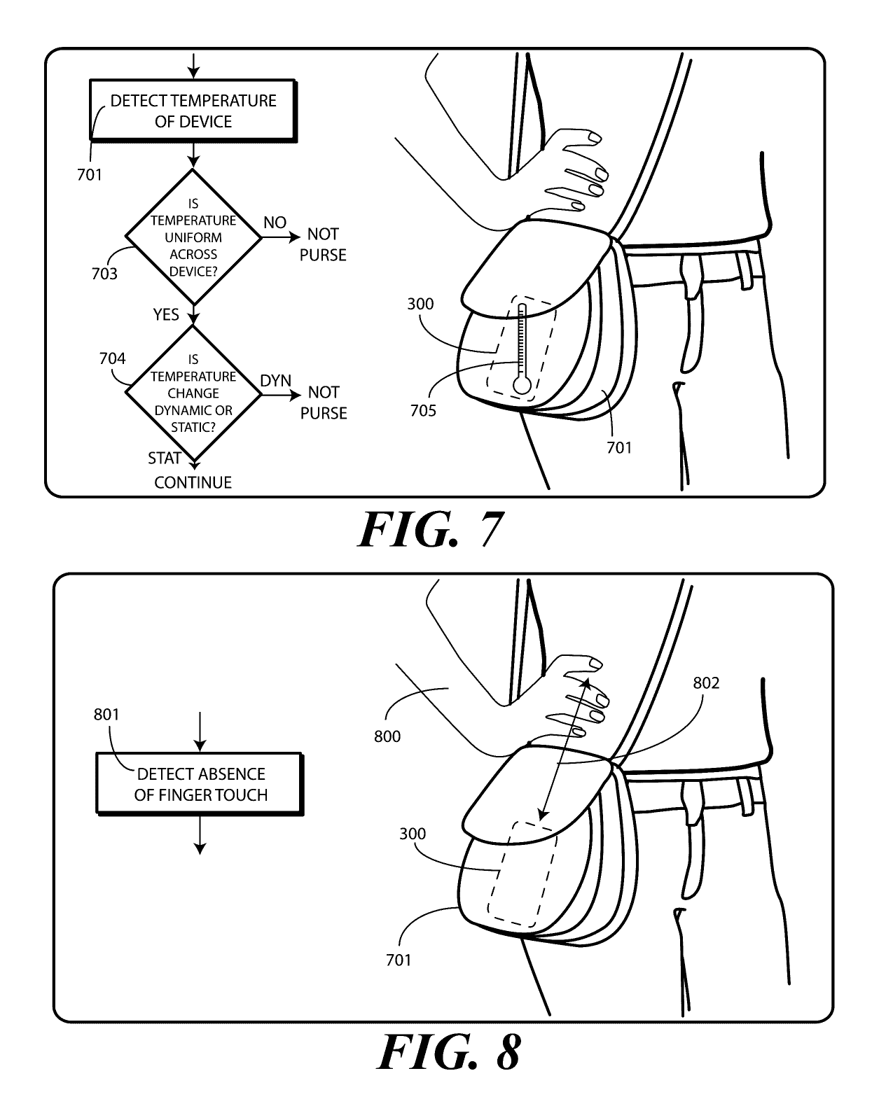

Turning now to FIG. 7, illustrated therein are the two temperature factors, which can be used separately or in combination in the function determining whether the electronic device 300 is disposed within a purse 701 or other repository container. As shown in FIG. 7, in one embodiment the one or more processors (316) can detect 702 the temperature 705 of the electronic device 300 using the temperature sensor (412) or alternatively the proximity sensor components (340). This temperature detection can be done for the electronic device 300 overall, at selective locations (520,521), or at a first end (350) and at a second end (351).

In one embodiment, shown at decision 703, the one or more processors (316) can determine if the temperature of the first location (520) of the electronic device 300 and/or the temperature at the second location (521) of the electronic device 300 define an approximately common temperature. As noted above, in one embodiment the approximately common temperature is defined by a temperature difference that is within a predefined range. In one illustrative embodiment, the temperature difference is plus or minus two degrees Fahrenheit. Other ranges will be obvious to those of ordinary skill in the art having the benefit of this disclosure. Where the temperature 705 is an approximately common temperature, this can indicate that there is no significant differential as would be the case if the user were holding either the first end (350) or the second end (351) in their hand with the other end in the air. This is indicative of the electronic device 300 being disposed within the purse 701.

In one embodiment, as shown at decision 704, the one or more processors (316) can determine if the temperature of the first location (520) of the electronic device 300 and/or the temperature at the second location (521) of the electronic device 300 defines an approximately static temperature. In one embodiment the approximately static temperature is defined by a temperature difference that remains within a predefined range for a predetermined temperature measurement interval. For example the one or more processors (316) can receive, from either the temperature sensor (412) or the one or more proximity detector components (341) a temperature reading at the first location (520) of the electronic device 300 and/or the temperature at the second location (521) at a first time. Some time later, perhaps five seconds, ten seconds, thirty seconds, or a minute later, the one or more processors (316) can receive another temperature reading at the first location (520) of the electronic device 300 and/or the temperature at the second location (521) at a second time. Where both temperature readings are within a predefined range, such as two degrees, three degrees, or five degrees Fahrenheit, this can indicate that there is no significant change in temperature along the housing (301) of the electronic device 300 as would be the case if the user was picking up the electronic device 300 or passing it from hand to hand. Accordingly, this can confirm that the electronic device 300 is disposed within the purse 701.

Turning now to FIG. 8, the one or more processors (316) can then detect 801 an absence 802 of touch sensor actuation along the housing (301) of the electronic device 300. When the electronic device 300 is disposed within the purse 701, the one or more processors (316) will accordingly detect that the user 800 is not touching the electronic device 300.

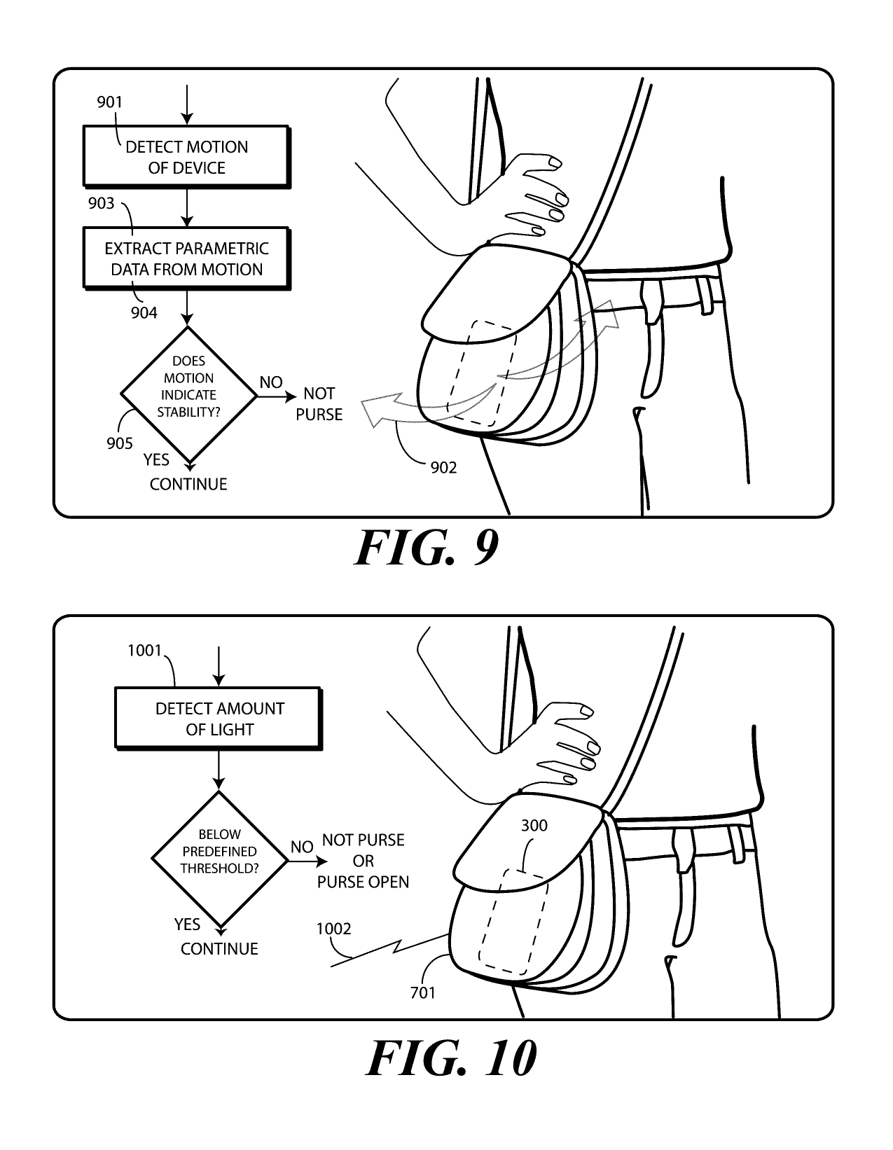

Turning now to FIG. 9, illustrated therein is the motion detection factor. As shown in FIG. 9, in one embodiment the one or more processors (316) of the electronic device 300 detect 901 motion 902 of the electronic device 300. The one or more processors (316) then extract 903 parametric data 904 from signals corresponding to the motion 902 as delivered by the motion sensor (342). The one or more processors (316) can then determine, as shown at decision 905, whether the motion 903 indicates an approximate rotational stability. In one embodiment the approximate rotational stability occurs when rotation of the electronic device 300 about any one axis is below a predetermined threshold. For example, in the purse 701 the electronic device 300 might swing back and forth, but not rotate more than about fifteen degrees about any one axis. Accordingly, when the rotation stays below this range, the one or more processors (316) can conclude that an approximately rotationally stable condition exists. Other ranges and limits will be obvious to those of ordinary skill in the art having the benefit of this disclosure.

Turning now to FIG. 10, the one or more processors (316) can detect 1001, with a light sensor (407), an intensity of received ambient light 1002 and/or whether ambient light 1002 or direct light is incident on the housing (301) of the electronic device 300. Of course, when the electronic device 300 is covered by the purse 701, intensity of the received ambient light 1002 will be below a predetermined threshold of lux, such as below one lux. In many cases, ambient light 1002 will not be incident on the housing 301 at all. Modern light sensors (407) are more than capable of determining intensity of ambient light 1002 that is received. Accordingly, in one or more embodiments the determination that the electronic device 300 is disposed within the purse 701 can further include determining, with a light sensor (407), that ambient light 1002 or direct light is not incident on the housing 301, or alternatively is below a predetermined threshold such as one lux.

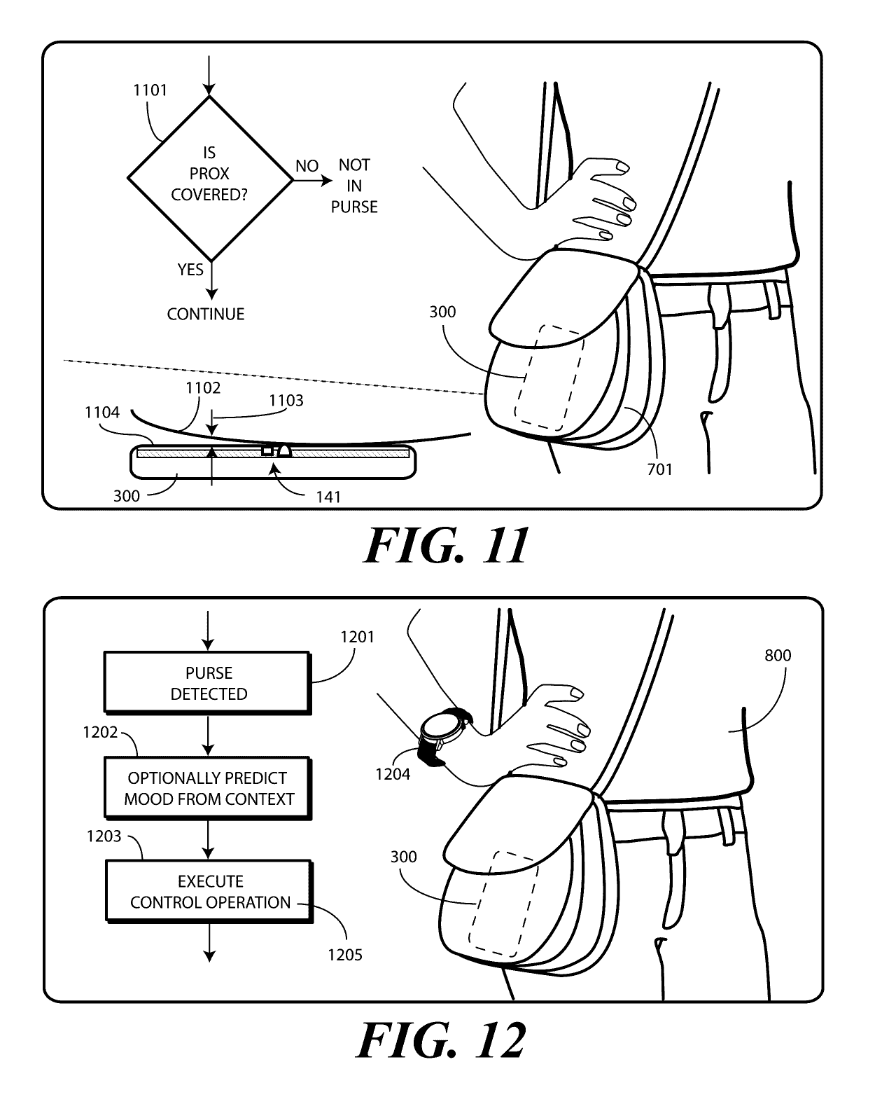

Turning now to FIG. 11, the one or more processors (316) can optionally further confirm that the electronic device 300 is in the purse 701 by determining 1101 whether an object 1102, such as clothing, textile materials, or other natural, synthetic, or blend layer, from which the purse 701 is manufactured, is covering the electronic device 300. This determination 1101 can be made when the one or more processors (316) receive signals from the one or more proximity detector components (341) indicating that an object 1102, such as textile material, is less than a predefined distance 1103 from a surface 1104 of the electronic device 300, thereby indicating that the electronic device 300 is covered by the object 1102. Where this occurs, the one or more processors (316) can further confirm that the electronic device 300 is disposed within the purse 701. This detection of an object 1102 covering the electronic device 300 can also serve as a confirmation that the electronic device 300 is not being touched as well.

The factors listed above can be used in the function of determining whether the electronic device 300 is disposed within a purse 701 alone or in combination. For example, the function can consider one, two, three, or all of the factors. Considering more factors assists in preventing false detection of the in-container condition. Embodiments of the disclosure contemplate that a user should be minimally affected due to false detection. Accordingly, in one embodiment the one or more processors (316) consider all factors. However, subsets of the factors can be useful in many applications.

Turning to FIG. 12, at step 1201 the in-container condition is confirmed. In one or more embodiments, the one or more processors (316) of the electronic device 300 can optionally determine the mood of the user 800 at step 1202. For example, the user 800 of FIG. 12 is wearing a companion wearable device 1204 that can track the user's pulse, skin temperature, activity level, and so forth. Using this information, which can be retrieved through a wireless communication protocol, the one or more processors (316) can determine a mood of the user 800 to further customize how the electronic device 300 will operate once the in-purse condition is detected. Recall from above that alerts can be whimsical or serious. If the user is in a good mood the one or more processors may deliver whimsical notifications. However, if the person is highly stressed, e.g., is late for work and running out the door, the notifications may have a more matter-of-fact contextual basis.

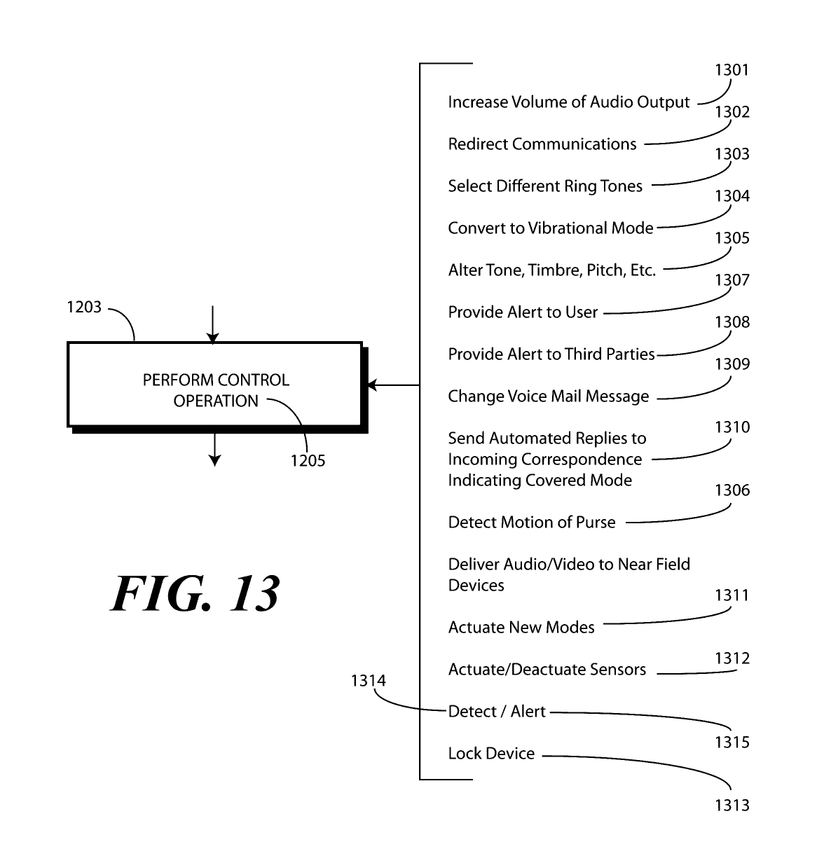

At step 1203, in response to detecting the in-container or in-purse condition, in one embodiment the one or more processors (316) can perform a control operation 1205. The control operation 1205 can take many forms. Turning now to FIG. 13, illustrated therein are a few possible control operations that can be performed. Others will be obvious to those of ordinary skill in the art having the benefit of this disclosure.

In one embodiment, the control operation 1205 of step 1203 can include increasing 1301 the volume of an audio output device. For example, the volume of loudspeakers can be increased when the electronic device (300) is enclosed within a repository container.

In another embodiment, the control operation 1205 of step 1203 can include detecting nearby companion electronic devices (such as wearable device (1204) of FIG. 12) and, where available, redirecting 1302, with a communication circuit (325) operable with the one or more processors (316), an incoming electronic communication from a remote electronic device to the companion electronic device. For example, the one or more processors (316) can wirelessly deliver audio, video, or combinations thereof to another electronic device disposed within a near-field communication radius of the electronic device (300). Accordingly, the user could see information normally presented on the display of the electronic device on another local device, e.g., a personal computer, without the need of removing the electronic device from the purse (701).

In another embodiment, the nearby electronic devices may comprise audio or video or communication systems in a vehicle. For example, a user may be in a vehicle having audio output devices, video output devices, or built-in communication devices such as On-Star.sup.™ safety systems or mobile phones. In one embodiment, when in the purse (701), the redirecting 1302 can include detecting one or more of the vehicular systems and, where available, wirelessly delivering audio, video, or combinations thereof to another electronic device disposed within the vehicle.

In an alternate embodiment, the device may transfer communication control. For example, if the user is in a vehicle and the electronic device is in the purse (701), the redirecting 1302 can include detecting nearby electronic devices and transferring functions to a complementary device. In this example, the electronic device (300) may forward phone functionality to the built-in phone system of the vehicle while the electronic device (300) is in the purse (701) and the purse (701) is in a vehicle. When the electronic device (300) is removed from the purse (701), or when the user exits the vehicle, the electronic device (300) can reclaim any functionality that was delegated due to container encapsulation.

In another embodiment, the control operation 1205 of step 1203 can include adjusting 1303 an output notification of one or more loudspeakers of the electronic device (300). For example, a unique ring tone can be selected for the in-purse mode of operation. The ring tone selected may be more audible through dense materials from which repository containers are made. In another embodiment, the control operation 1205 of step 1203 can include actuating 1304 a vibration mode of the electronic device (300). In yet another embodiment, the control operation 1205 of step 1203 can include adjusting 1305 one or more of a pitch, tone, spectral content, pattern, timbre, or combinations thereof of alert tones emitted by the electronic device. For example, a ring tone could be spectrally altered to better penetrate through the walls of a repository container.

In another embodiment, the control operation 1205 of step 1203 can comprise monitoring 1306 a motion sensor (342) and detecting a predefined motion. Once the predefined motion is detected, the control operation 1205 of step 1203 can further include delivering 1307, with an output device such as a loudspeaker, a notification that the electronic device (300) is disposed within the purse (701). For example, in one embodiment the predefined motion comprises a tap or a double tap. In such an embodiment, the notification can include an audible message saying, “You found me!” Accordingly, a user (800) may be able to double-tap on the side of a purse (701), which causes the motion sensor (342) to detect this predefined motion. The one or more processors (316) can then play a message through a loudspeaker saying, “You found me!” This allows the user (800) to determine that the electronic device (300) is disposed within the purse (701) without having to open the purse (701). The notifications can take other forms, of course, including a vibration, alert beep, or other indicator to notify the user (800) that the electronic device (300) is in the purse (701).

In another embodiment, the control operation 1205 of step 1203 can include transmitting 1308 one or more notification messages. For example, when incoming messages or calls are received, an automatic notification may be returned indicating that the user (800) may not be aware that the incoming communication was received due to the in-purse condition.

In yet another embodiment, the control operation 1205 of step 1203 can include changing 1309 a voice mail message or sending 1310 automated replies to incoming communications. A pre-recorded voice mail message may be changed from “I'm available but don't have my phone in my hand,” to “I cannot answer the phone.” Such a change in a voice mail message may be dependent, in one embodiment, upon a contextual data comparison with expected contextual data.

In another embodiment, the control operation 1205 of step 1203 can include actuating 1311 new modes of operation. For example, the control operation 1205 of step 1203 can include causing the electronic device (300) to enter a power saving operational mode. Alternatively, a near-field communication mode may be launched to locate audio or video output devices proximately located with the user (800). In yet another embodiment, sensors or electronic components can be deactuated 1312 when the electronic device is in-container. For example, the display of the electronic device may be turned OFF until the device is removed from the purse (701).

The examples above are illustrative only. In another embodiment, the control operation 1205 of step 1203 can also include locking 1413 a user interface device (311) of the electronic device (300) as well.

If the purse (701) is stationary, any incoming message may be unheard or missed by the user (800). For example, if the user (800) is away, and the purse (701) is sitting stationary by itself, the user (800) may not hear an incoming communication. Accordingly, in another embodiment, the control operation 1205 of step 1203 can include monitoring 1306 the motion sensor (342). After an incoming communication from a remote electronic device is received, the motion sensor (342) can detect a predefined motion such as the user (800) grabbing the purse (701). When this occurs, the control operation 1205 of step 1203 can further include delivering 1315, with an output device, a notification that the incoming communication was received. Accordingly, when the user (800) grabs the purse (701) again, this is detected by the motion sensor (342) and the electronic device (300) announces alerts of received messages again, and perhaps louder expecting user the (800) to now be able to hear the notifications.

Other steps will be obvious to those of ordinary skill in the art having the benefit of this disclosure. For instance, where the electronic device (300) includes multiple microphones, the control operation 1205 of step 1203 can include would select a microphone from the array that is least obscured or that provides the best performance. The control operation 1205 of step 1203 can include enabling or disabling a touch-sensitive display, turning OFF backlighting features of a user interface or display, turning OFF unnecessary features or functions, disabling wireless links, and so forth. In one or more embodiments, the control operation 1205 of step 1203 occurs only where the electronic device is fully disposed within a repository container, as a partially covered device may work fine without changing the operating mode.

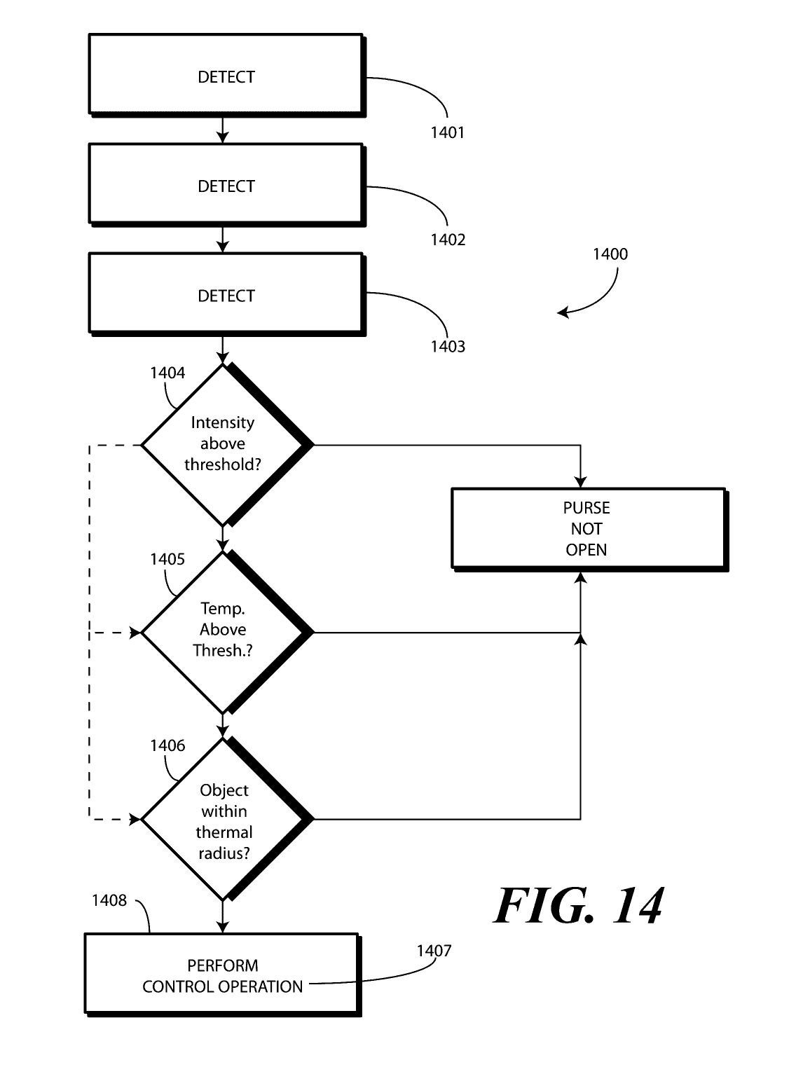

In one or more embodiments, the one or more processors (316) of the electronic device (300) can further determine, when in a repository container, that the repository container is opened. Turning now to FIG. 14, illustrated therein is one method 1400 for making this determination. Steps 1401,1402,1403 each provide possible ways to detect, with the one or more sensors, a condition indicating that the repository container is open. These steps 1401,1402,1403 can be performed in the alternative or in combination.

At step 1401, the method 1400 includes determining that the intensity of received ambient light (1002) transitions above the predefined threshold. For example, if the electronic device (300) is disposed within a purse (701) that is closed, no ambient light (1002) will reach the light sensor (407). However, when the purse (701) is opened, some light will enter. Where the predetermined threshold is set to, for example, one lux, this can cause the intensity of the received ambient light (1002) to rise above the threshold as determined at decision 1404, thereby indicating that the purse (701) has been opened.

At step 1402, the method 1400 includes detecting a thermal object moving within a predefined thermal radius of the electronic device (300). In many instances, where a user (800) opens a repository container such as a purse (701), they will intuitively stick their hand into the purse (701) to withdraw an object. Their hand, which emits heat, constitutes a thermal object. When this thermal object comes within a predetermined thermal radius of the electronic device (300), as detected by the proximity sensor components (340) and determined at decision 1406, this indicates that the container has been opened.

At step 1403, the method 1400 includes detecting an ambient temperature change occurring beyond a predefined threshold. Embodiments of the disclosure contemplate that when a repository container is opened, there can be a sudden shift in temperature due to the inrush of air. In one or more embodiments, one or more of the temperature sensor (412) or the proximity sensor components (340) can detect this temperature change, and determine at decision 1406 whether it is beyond a predefined threshold such as three or four degrees. Where this is the case, this indicates that the repository container has been opened.

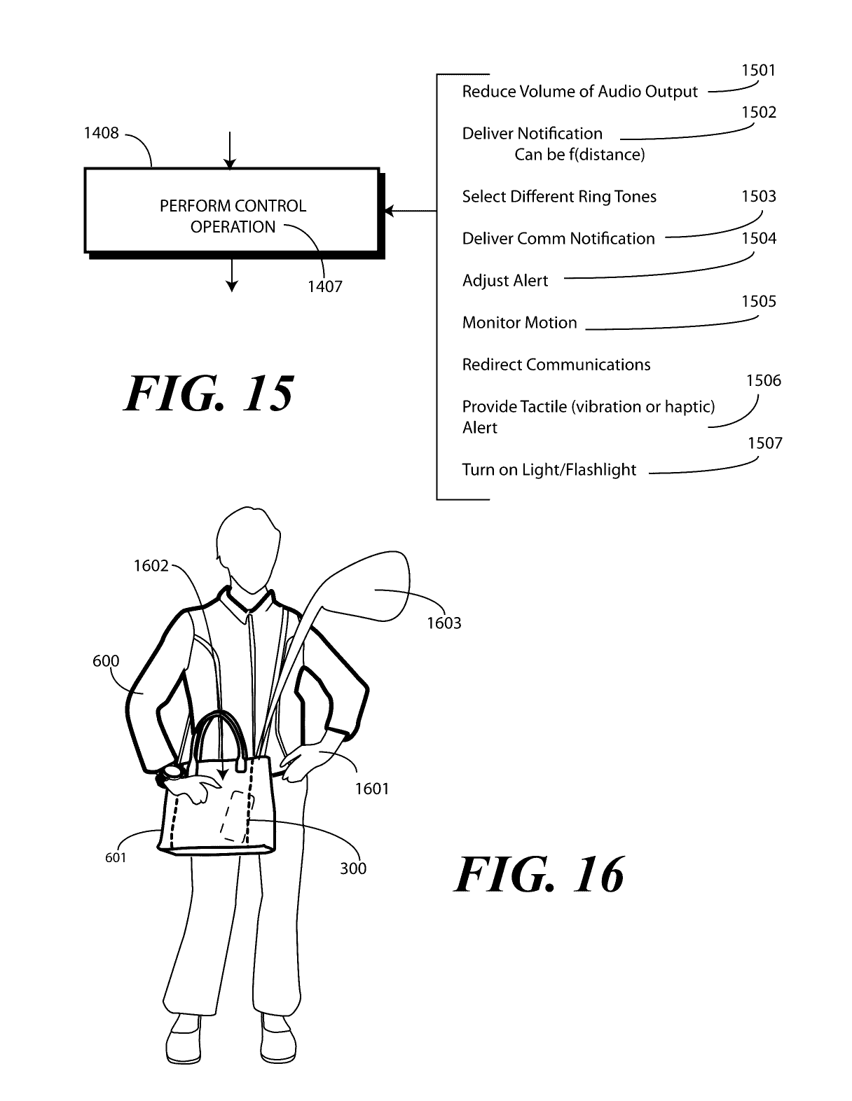

In one or more embodiments, where the repository container has been opened, method 1400 can include performing, by the one or more processors (316) another control operation 1407 at step 1408. As with the control operation (1205) of step (1203), the control operation 1407 at step 1408 can take various forms. Turning now to FIG. 15, illustrated therein are a few examples. Still others will be obvious to those of ordinary skill in the art having the benefit of this disclosure.

In one embodiment, the control operation 1407 of step 1408 includes reducing 1501 a volume of an audio output device. For example, when the in-container or in-purse condition was detected at step (1203) of FIG. 12, a control operation (1205) could include increasing (1301) the volume of an audio output device. For example, the volume of loudspeakers can be increased when the electronic device (300) is enclosed within a repository container. Accordingly, when the container is opened, the control operation 1407 of step 1408 includes reducing 1501 a volume of an audio output device.

In another embodiment, the control operation 1407 of step 1408 can include delivering 1502, with an output device, a notification that the electronic device (300) is disposed within the repository container or purse (701). The notification may include an audible message saying, “Hello, this is your phone, Buster. I'm hiding in your purse and you found me!” Other notifications will be obvious to those of ordinary skill in the art having the benefit of this disclosure.

In one or more embodiments, this notification can optionally be a function of a distance between a thermal object, such as the user's hand, and the electronic device (300). Recall from above that in many instances, where a user (800) opens a repository container such as a purse (701), they will intuitively stick their hand into the purse (701) to withdraw an object. Their hand, which emits heat, constitutes a thermal object. When this thermal object comes within a predetermined thermal radius of the electronic device (300), it can be detected by the proximity sensor components (340). In one or more embodiments, the notification delivered 1502 as part of the control operation 1407 of step 1408 can change as the hand gets closer and closer. In one embodiment, an approaching hand diving into the purse (701) causes the notification to be a sonar-type alert with a Doppler effect that changes pitch/pattern/level/type of notification as a function of the distance between approaching hand and the electronic device (300) to allow the user (800) to converge to the electronic device (300) without looking.

In yet another embodiment, the control operation 1407 of step 1408 can include adjusting 1504 one or more of a pitch, tone, spectral content, pattern, timbre, or combinations thereof of alert tones emitted by the electronic device (300). For example, a ring tone could be changed from a loud, ear-piercing tone to a soft musical tone.

If the purse (701) is moving, for example in a car, it may not be appropriate for a user (800) to respond by manipulating the electronic device (300). Accordingly, in another embodiment, the control operation 1407 of step 1408 can include monitoring 1505 the motion sensor (342). When an incoming communication from a remote electronic device is received, and the purse (701) is opened, the control operation 1407 of step 1408 can also include redirecting 1506, with a communication circuit (325) operable with the one or more processors (316), the incoming electronic communication to another electronic device disposed within a near-field communication radius of the electronic device (300), such as the vehicular audio system. As with FIG. 13 above, other steps will be obvious to those of ordinary skill in the art having the benefit of this disclosure.

In some instances a physical sensation may be preferred over audible notifications. For example, a person may be in a quiet environment and may need to quickly find an electronic device (300) disposed within a crowded purse. Accordingly, in yet another embodiment the control operation 1407 can comprise delivering 1506 a tactile or vibrational alert. For example, the control operation 1407 can comprise actuating a motion generation device to deliver haptic or vibrational output when, for example, the one or more proximity sensors detect a user's hand within a predefined thermal radius. This provides a quick and easy way for the person to find the electronic device (300) in a purse without looking and without disturbing others.

In another embodiment, it could be helpful to have light within the purse so that the electronic device (300) could quickly be found. Accordingly, in another embodiment the control operation 1407 can comprise turning on a light 1507, such as a camera flash or flashlight on the electronic device (300). Such a control operation 1407 can help a user look for other items in their cluttered purse.

FIGS. 16-18 illustrate a few use cases showing an electronic device 300 configured in accordance with one or more embodiments of the disclosure in use. Beginning with FIG. 16, a user 600 is shown with a purse 601. The purse 601 is closed. The electronic device 300 is disposed within the purse 601 and, with the temperature sensor (412) or proximity sensor components (340) detect a uniform temperature at multiple locations along the electronic device 300. Additionally, the temperature sensor (412) or proximity sensor components (340) detect that the temperature is not changing, as would likely be the case when the electronic device 300 was being touched. The light sensor (407) detects that the environment within the purse 601 is dark, as no ambient light (1002) is being received. The touch sensor (355) detects an absence of finger touch, indicating that the housing (301) of the electronic device 300 is not being touched. The motion sensor (342) indicates that no serious rotations are occurring as would be the case if the electronic device 300 were in the user's hand 1601 when walking, or was being swapped between hands, or was going from a flat table to the user's hand 1601. Any of these operations would cause the orientations of the electronic device 300 to change from up to down to angled, and so forth. By contrast, when the electronic device 300 is disposed within the purse 601, its orientation stays relatively the same. Given these conditions, the one or more processors (316) of the electronic device (300) detect an in-purse context.

As shown in FIG. 16, the user 600 is delivering a double-tap 1602 to the side of the purse 601. The one or more processors (316) detect this predefined motion with the motion sensors (342). In one embodiment, upon detecting the predefined motion, the one or more processors (316) deliver, with an output device, a notification 1603 to the user 600. In one embodiment, the notification 1603 indicates that the electronic device 300 is disposed within the purse 601. In another embodiment, the notification 1603 indicates that an incoming electronic communication was received. Other types of notifications will be obvious to those of ordinary skill in the art having the benefit of this disclosure.

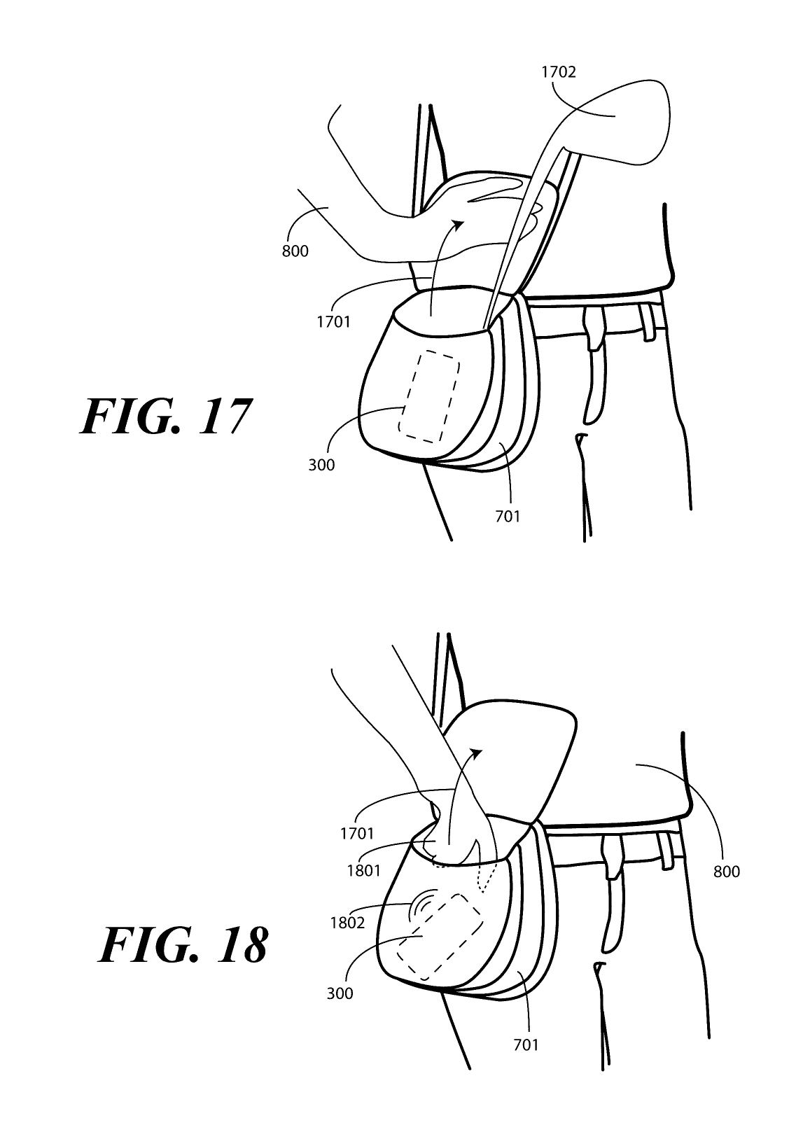

Turning now to FIG. 17, another user 800 has opened 1701 a purse 701 with an electronic device 300 disposed therein after the in-purse condition was detected. As noted above, the fact that the purse 701 was opened 1701 can be detected in several ways. In one embodiment, when the purse 701 is opened 1701, there is a sudden shift in temperature that is detected by one or more of the temperature sensor (412) or the proximity sensor components (340). Alternatively, the fact that the purse 701 was opened 1701 can be detected when an approaching hand dives into the purse 701 as detected by the proximity sensor components (340). Alternatively, an inrush of ambient light (1002) may be detected by the light sensor (407).

In one or more embodiments, when the one or more processors (316) of the electronic device 300 detect that the purse 701 was opened, a notification 1702 can be delivered to the user 800 with an output device. For example, the notification 1702 can alert the user 800 that the electronic device 300 is disposed within the purse 701. Alternatively, the notification 1702 can sound a sonar type alert in response to an approaching hand to allow the user 800 to converge to the electronic device's location without looking as previously described. In another embodiment, the notification 1702 can alert the user 800 of missed messages for the first time. In another embodiment, the notification 1702 can announce alerts of received message again, and perhaps louder, expecting the user 800 to hear the notification 1702. Other types of notifications will be obvious to those of ordinary skill in the art having the benefit of this disclosure.

In FIG. 18, user 800 has opened 1701 a purse 701 with an electronic device 300 disposed therein after the in-purse condition was detected. The user 800 then places her hand 1801 into the purse 701. As noted above, the fact that the purse 701 was opened 1701 can be detected when an approaching hand 1801 dives into the purse 701 by the proximity sensor components (340). In one or more embodiments, when the one or more processors (316) of the electronic device 300 detect that the purse 701 was opened, a notification can be delivered to the user 800 with an output device. In one embodiment, the notification comprises a physical alert 1802, such as a vibration or haptic thump produced by a motion detection device in response to the proximity sensor components (340) detecting the hand 1801 within the thermal radius of the electronic device 300. This provides a quick and easy way for the person to find the electronic device 300 in a purse without looking. The one or more processors (316) can be configured to actuate the motion generation device to deliver the physical alert 1802 alone or in combination with other outputs such as audible outputs.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for controlling an electronic device, comprising:
detecting, with one or more sensors, the electronic device is disposed within a repository container as a function of at least:
an intensity of received ambient light is below a predefined threshold;
an absence of touch sensor actuation along a housing of the electronic device; and
an approximately common temperature occurring at both a first location of the electronic device and a second location of the electronic device; and
performing, by one or more processors operable with the one or more sensors, a control operation in response to the electronic device being disposed within the repository container.

2. The method of claim 1, the function further of at least a motion of the electronic device defined by parametric data indicating an approximate rotational stability of the electronic device.

3. The method of claim 2, further comprising detecting:
with a motion sensor, the motion of the electronic device;
with a touch sensor, the absence of touch sensor actuation;
with a light sensor, the intensity of received ambient light; and
with one or more proximity sensor components, the approximately common temperature.

4. The method of claim 1, the approximately common temperature defined by a temperature difference of plus or minus two degrees Fahrenheit, or less, between the first location of the electronic device and the second location of the electronic device.

5. The method of claim 4, the function at least further of an approximately static temperature occurring at the first location or the second location during a predetermined temperature measurement interval.

6. The method of claim 1, the control operation comprising increasing a volume of an audio output device.

7. The method of claim 1, the control operation comprising monitoring a motion detector, the method further comprising:
detecting, with the motion detector, a predefined motion; and
upon detecting the predefined motion, delivering, with an output device, a notification that the electronic device is disposed within the repository container.

8. The method of claim 1, the control operation comprising delivering, with a communication circuit operable with the one or more processors, a preformatted response message in response to receiving an incoming communication from a remote electronic device.

9. The method of claim 1, the control operation comprising monitoring a motion detector, the method further comprising:
receiving, with a communication circuit operable with the one or more processors, an incoming communication from a remote electronic device;
detecting, with the motion detector, a predefined motion; and
upon detecting the predefined motion, delivering, with an output device, a notification that the incoming communication was received.

10. The method of claim 1, further comprising:
detecting, with the one or more sensors, a condition indicating that the repository container is open, the condition comprising one or more of:
the intensity of received ambient light transitioning above the predefined threshold; or
an ambient temperature change occurring beyond a temperature predefined threshold; or
a thermal object moving within a predefined thermal radius of the electronic device; and
in response to detecting the condition, performing, by the one or more processors, another control operation.

11. The method of claim 10, the another control operation comprising reducing a volume of an audio output device.

12. The method of claim 10, the another control operation comprising delivering, with an output device, a notification that the electronic device is disposed within the repository container.

13. The method of claim 10, the another control operation comprising, delivering, with an output device, a notification that an incoming electronic communication from a remote electronic device was received while the repository container was closed.

14. The method of claim 10, the another control operation comprising redirecting, with a communication circuit operable with the one or more processors, an incoming electronic communication from a remote electronic device to a companion electronic device of the electronic device.

15. An electronic device, comprising:
one or more processors;
a light sensor operable with the one or more processors;
a touch sensor operable with the one or more processors; and
one or more proximity sensors operable with the one or more processors;
the one or more processors to determine:
an intensity of received ambient light from the light sensor;
an absence of touch sensor actuation along a housing of the electronic device from the touch sensor; and
whether a temperature detected at both a first location of the electronic device and a second location of the electronic device is within a predefined range;
the one or more processors to confirm that the electronic device is disposed within a repository container when:
the intensity of received ambient light, as detected by the light sensor, is below a predefined threshold;
the absence of touch sensor actuation is confirmed; and
the temperature at both the first location and the second location is within the predefined range;
the one or more processors to perform a control operation in response to confirming the electronic device is disposed within the repository container.

16. The electronic device of claim 15, further comprising a motion detector operable with the one or more processors, the one or more processors to further confirm that the electronic device is disposed within the repository container when motion of the electronic device, as determined by the motion detector, is defined by parametric data indicating approximate rotational stability of the electronic device.

17. The electronic device of claim 15, the control operation comprising one or more of:
increasing a volume of an audio output device;
delivering, with a communication circuit operable with the one or more processors, a preformatted response message in response to receiving an incoming communication from a remote electronic device; or
monitoring a motion detector.

18. The electronic device of claim 15, the one or more processors to confirm that the repository container is open when:
the intensity of received ambient light, as detected by the light detector, transitions above the predefined threshold;
an ambient temperature increase, as detected by the one or more proximity sensors, exceeds a predefined temperature threshold; or
a thermal object moves within a predefined thermal radius of the electronic device as detected by the one or more proximity sensors;
the one or more processors further to, upon confirming that the repository container is open, perform another control operation.

19. The electronic device of claim 18, the another control operation comprising one or more of:
reducing a volume of an audio output device;
delivering a physical alert with a motion generation device;
delivering, with a user interface device, a notification that the electronic device is disposed within the repository container;
delivering, with the user interface device, another notification that an incoming electronic communication from a remote electronic device was received while the repository container was closed; or
redirecting, with a communication circuit operable with the one or more processors, the incoming electronic communication from the remote electronic device to a companion electronic device of the electronic device.

20. The electronic device of claim 15, the repository container comprising a purse, each proximity sensor comprising a proximity sensor component comprising an infrared signal receiver to receive an infrared emission from an object external to the housing.
